(19) United States
(12) Patent Application Publication
(10) Pub. No.: US 2014/0307523 A1
(43) Pub. Date: Oct. 16, 2014

(54) BURIED ARRAY WIRELESS EXPLORATION SEISMIC SYSTEM

(71) Applicant: Wireless Seismic, Inc., Louisville, CO (US)

(72) Inventors: Keith Elder, Richmond, TX (US); Douglas B. Crice, Grass Valley, CA (US)

(73) Assignee: Wireless Seismic, Inc., Louisville, CO (US)

(21) Appl. No.: 14/206,637

(22) Filed: Mar. 12, 2014

Related U.S. Application Data
(60) Provisional application No. 61/792,871, filed on Mar. 15, 2013.

(51) Int. Cl. G01V 1/22

(52) U.S. Cl. CPC G01V 1/22; G01V 1/40
USPC 367/25; 367/37

(57) ABSTRACT

Systems and methods are provided for acquiring data using a wireless network and a number of nodes that may be configured to collect acquired data and forward data to a central recording and control system. The acquired data may include seismic and/or auxiliary data. A node for use in data acquisition may include an acquisition module in operative communication with a buried sensor array operable to output acquired data. The processor may also be operable to receive acquired data from another data acquisition module in the wireless network.

### CROSS-REFERENCE TO RELATED APPLICATION

This application claims priority from U.S. Provisional Application No. 61/792,871 filed on Mar. 15, 2013 entitled “BURIED ARRAY WIRELESS EXPLORATION SEISMIC SYSTEM,” the contents of which are incorporated by reference herein as if set forth in full.

### BACKGROUND

Seismic surveys are often used by natural resource exploration companies and other entities to create images of subsurface geologic structure. These images may be used to determine the optimum places to drill for oil and gas and to plan and monitor enhanced resource recovery programs among other applications. Seismic surveys may also be used in a variety of contexts outside of oil exploration such as, for example, locating subterranean water and planning road construction. Additionally, seismic monitoring of subterranean activity (e.g., hydraulic fracturing) may be provided using seismic survey systems.

One approach to seismic surveys has been to conduct the survey by placing an array of vibration sensors (accelerometers or velocity sensors called “geophones”) on the ground, typically in a line or in a grid of rectangular or other geometry. Vibrations may be created either by explosives or a mechanical device such as a vibrating energy source or a weight drop or vibrations associated with a subterranean activity may be created. Multiple energy sources may be used for some surveys. The vibrations from the energy source propagate through the earth, taking various paths, refracting and reflecting from discontinuities in the subsurface, and are detected by the array of vibration sensors. Signals from the sensors are amplified and digitized, either by separate electronics or internally in the case of “digital” sensors. The survey might also be performed passively by recording natural vibrations in the earth.

The digital data from a multiplicity of sensors is eventually recorded on storage media, for example magnetic tape, or magnetic or optical disks, or other memory device, along with related information pertaining to the survey and the energy source. The energy source and/or the active sensors are relocated and the process continued until a multiplicity of seismic records is obtained to comprise a seismic survey. Data from the survey are processed on computers to create the desired information about subsurface geologic structure.

In general, as more sensors are used, placed closer together, and/or cover a wider area, the quality of the resulting image will improve. It has become common to use thousands of sensors in a seismic survey stretching over an area measured in square kilometers. Hundreds of kilometers of cables may be laid on the ground and used to connect these sensors. Large numbers of workers, motor vehicles, and helicopters are typically used to deploy and retrieve these cables. Exploration companies would generally prefer to conduct surveys with more sensors located closer together. However, additional sensors require even more cables and further raise the cost of the survey. Economic tradeoffs between the cost of the survey and the number of sensors generally demand compromises in the quality of the survey.

In addition to the logistic costs, cables create reliability problems. Besides normal wear-and-tear from handling, they are often damaged by animals, vehicles, lightning strikes, and other problems. Considerable field time is expended troubleshooting cable problems. The extra logistics effort also adds to the environmental impact of the survey, which, among other things, adds to the cost of a survey or eliminates surveys in some environmentally sensitive areas.

As a result, wireless acquisition units have been developed to do away with the burdensome nature of cables in such a system. For instance, U.S. Pat. No. 7,773,457, which is hereby incorporated in its entirety by reference as if reproduced herein, describes a system for performing a seismic survey using wireless acquisition units.

Seismic surveys may also be used to monitor subterranean activities associated with drilling or other production techniques. For example, the prevalence of hydraulic fracturing operations has been increasing. In hydraulic fracturing operations, a pressurized fluid is introduced into a well that results in the propagation of fractures in a rock layer. Accordingly, the additional fractures in the rock layer may create conduits along which gas and petroleum from source rocks may migrate to reservoir rocks. Monitoring techniques have been proposed to measure the seismic activity induced by the hydraulic fracturing operation so as to monitor the hydraulic fracturing operation for improved safety or efficiency.

### SUMMARY

The present disclosure is generally directed to methods and apparatus for use in seismic monitoring. In particular, the present disclosure relates to systems and methods for gathering seismic monitoring data wherein sensors are disposed below the surface of the Earth to monitor a subterranean activity, for example, a hydraulic fracturing operation.

As described above, seismic monitoring techniques have been proposed for use in conjunction with monitoring subterranean activities. However, such techniques have heretofore been limited to traditional surface monitoring approaches wherein seismic sensors (e.g., geophones) are disposed on the surface to record seismic activity received at the surface. Other approaches have been proposed where sensors are disposed in a well that is taken out of production such that instruments may be disposed within the well below the surface to monitor seismic activity at a depth below the surface.

However, both of the previously contemplated approaches suffer from disadvantages. For example, surface arrays may be subject to significant noise at the surface. For example, livestock, vehicles, weather, or other surface events may introduce noise (e.g., vibrations unrelated to the seismic activity to be monitored) at the surface sensors. The seismic activity desired to be monitored in the context of subterranean activities such as hydraulic fracturing may be at a level near or below the noise level when received at the surface such that distinguishing useful seismic data from noise at the surface may be difficult.

In the well approach, surface noise may be reduced, however, such monitoring may be extremely costly as a well that could otherwise be used in production or exploration must be taken out of production and dedicated to monitoring. As such, the use of wells for monitoring is limited. Furthermore, wells are often isolated in a production field such that for a given well, there may not be adjacent wells available for monitoring. Drilling additional wells solely for the purpose of monitoring may be cost prohibitive. In this regard, only a portion of an active field may be monitored as the cost to take additional wells out of service or to drill additional wells may be prohibitive. Also, well degradation may occur such that once a well is used for monitoring, production or exploration may no longer be possible.

Accordingly, systems are described herein that include an array of sensors that may be spaced throughout the array that are disposed below the surface of the Earth, yet not within existing well-bores.

A first aspect includes a data acquisition module for use in seismic data acquisition. The module may include at least one buried seismic sensor operable to output acquired seismic data and a processor in operative communication with the buried seismic sensor to receive the acquired seismic data. The module may also include a transmitter in operative communication with the processor for transmitting the acquired seismic data to one of a downstream data acquisition module or a data collection unit. In turn, a receiver in operative communication with the processor for receiving seismic data from an upstream data acquisition module may also be provided. The data acquisition module may be disposed in a serial data transfer path of an array of a plurality of data acquisition modules.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in an embodiment, the buried seismic sensor may be disposed completely below the surface of the Earth. Additionally, a plurality of buried seismic sensors may be in operative communication with the processor. In turn, different respective ones of the plurality of seismic sensors may be disposed at different corresponding depths below the surface of the Earth.

In an embodiment, the data acquisition module may be deployed into a production field comprising a plurality of wells. At least one of the wells may be employed in a subterranean activity at a first depth below the surface. As such, the buried seismic sensor may be disposed at a second depth not less than about 10% of the first depth from the surface and not more than about 70% of the first depth from the surface. In an application, the subterranean activity may comprise hydraulic fracturing. Accordingly, the seismic data may comprise a hydrocenter and a magnitude of a seismic event corresponding to the hydraulic fracturing.

In an embodiment, the buried seismic sensor may be disposed at a depth below the weathered layer. For instance, the buried seismic sensor may be disposed at a depth below the weathered layer not less than 5 m and not more than 200 m. The weathered layer may extend from the surface of the Earth to a depth of not less than 5 m and not more than 100 m below the surface of the Earth. Additionally, it may be appreciated that the depth of the weathered layer may vary based on location.

In an embodiment, the buried seismic sensor may be disposed at a depth below the surface of the Earth not less than 5 m and not more than 500 m. The buried seismic sensor may be disposed at a depth below the surface of the Earth sufficient to substantially isolate the plurality of buried seismic sensors from seismic waves originating at the surface. For example, the buried seismic sensor may be disposed at a depth below the surface of the Earth such that a signal to surface noise ratio is less than about 5:1.

In an embodiment, the buried seismic sensor may include a three component sensor. Each component of the three component sensor may be operable to output acquired data. As such, the processor may be configured to receive the output seismic data from one component of the three component sensor in a first circumstance, from two components of the three component sensor in a second circumstance, and from all three components of the three component sensor in a third circumstance. The first circumstance may include activating one component of the three component sensor, the second circumstance may include activating two components of the three component sensor, and the third circumstance may include activating three components of the three component sensor.

In an embodiment, the processor may be operable to communicate auxiliary data to the transmitter for transmission to at least one of another data acquisition module, a data collection module, or a command and control center. The auxiliary data may include status information regarding at least a portion of the module. The auxiliary data may, for example, include status data regarding the buried seismic sensor. Additionally, in an embodiment, the module may include a power supply for supplying power to the data acquisition module. For example, the power device may include at least one of a battery, solar source, or wind source. As such, the auxiliary data may include status data regarding the power device. In an embodiment, the auxiliary data may include environmental conditions in which the data acquisition module is disposed. In this regard, the environmental conditions associated with the data acquisition module may include at least one of noise, ambient weather, or orientation of the data acquisition module. For example, the ambient weather comprises at least one of temperature, a solar condition, or a wind condition and the orientation of the data acquisition module comprises a tilt angle.

A second aspect includes a method for use in data acquisition. The method may include disposing at least one seismic sensor at a predetermined depth below the surface of the Earth at a plurality of corresponding predetermined surface locations and establishing operative communication between a data acquisition module and the at least one seismic sensor at each of the plurality of predetermined surface locations. The method may also include creating a wireless serial data transfer path between one or more of the data acquisition modules at the plurality of predetermined surface locations for relaying data from an upstream acquisition module to at least one of a downstream acquisition module, a data collection module, or a command and control center. The method may further include receiving acquired seismic data from the at least one seismic sensor at least at a portion of the acquisition modules and wirelessly communicating the acquired seismic data along the wireless serial data transfer path.

A number of feature refinements and additional features are applicable to the second aspect. These feature refinements and additional features may be used individually or in any combination. As such, each of the following features that will be discussed may be, but are not required to be, used with any other feature or combination of features of the second aspect.

For example, the disposing may include burying the seismic sensor completely below the surface of the Earth. In an embodiment, the plurality of predetermined surface locations may be in a production field comprising a plurality of wells. At least one of the wells may be employed in a subterranean activity at a first depth below the surface and the disposing comprises locating the at least one seismic sensor at a second depth not less than about 10% of the first depth from the surface and not more than about 70% of the first depth from the surface. In an embodiment, the subterranean activity may include performing hydraulic fracturing at the first depth. For example, the seismic data may include a hydrocenter and a magnitude of a seismic event corresponding to the hydraulic fracturing.

In an embodiment, the disposing may include burying the seismic sensor at a depth below the weathered layer. The disposing may include burying the seismic sensor at a depth below the weathered layer not less than 5 m and not more than 100 m. The weathered layer may extend from the surface of the Earth to a depth of not less than 5 m and not more than 100 m below the surface of the Earth. However, it may also be appreciated that the depth of the weathered layer may vary depending upon location.

In an embodiment, the disposing may include burying the seismic sensor at a depth below the surface of the Earth not less than 5 m and not more than 500 m. For example, the disposing may include burying the seismic sensor at a depth below the surface of the Earth sufficient to substantially isolate the plurality of buried seismic sensors from seismic waves originating at the surface. The disposing may include burying the seismic sensor at a depth below the surface of the Earth such that a signal to surface noise ratio is less than about 5:1.

In an embodiment, the method may include communicating auxiliary data from the data acquisition module to at least one of anther data acquisition module, a data collection module, or a command and control center. The auxiliary data may include status information regarding at least a portion of the module. For instance, the auxiliary data may status data regarding the buried seismic sensor. As such, the method may also include supplying power to the data acquisition module from a power supply such as, for example, from at least one of a battery, solar source, or wind source. Accordingly, the auxiliary data may include status data regarding the power supply. Additionally or alternatively, the auxiliary data comprises environmental conditions in which the data acquisition module is disposed. The environmental conditions associated with the data acquisition module may include at least one of noise, ambient weather, or orientation of the data acquisition module. For instance, the ambient weather may include at least one of temperature, a solar condition, or a wind condition and the orientation of the data acquisition module comprises a tilt angle.

### BRIEF DESCRIPTION OF THE DRAWINGS

FIG. 1 is a block diagram of a seismic monitoring system in accordance with an embodiment of the present disclosure.

FIG. 2 is a schematic view of an embodiment of a data acquisition module of FIG. 1.

FIG. 3 is a cross-section view of a section of subterranean layers in which a hydraulic fracturing operation may be performed in accordance with an embodiment of the present disclosure.

FIG. 4 illustrates a production field with deployed acquisition modules at a plurality of predetermined surface locations in accordance with an embodiment of the present disclosure.

FIG. 5A illustrates an embodiment of a deployment of an embodiment of a seismic monitoring system.

FIG. 5B an embodiment of a plurality of buried seismic sensors disposed below the surface of the Earth.

FIG. 6 is a schematic illustrating an embodiment of a seismic monitoring system including a plurality of acquisition nodes, a node to node network, a backhaul network, and a command and control center.

FIG. 7 is a schematic illustrating another embodiment of a seismic monitoring system including a plurality of acquisition nodes, a node to node network, and a backhaul network.

FIG. 8 illustrates an embodiment of a node according to an embodiment of the present disclosure.

FIG. 9 is a schematic illustrating another embodiment of node to node communications and autonomous nodes in a deployed seismic monitoring system in accordance with the present disclosure.

FIG. 10 is a flowchart illustrating an embodiment for operating a seismic monitoring system in accordance with the present disclosure.

### DETAILED DESCRIPTION

The following description is not intended to limit the disclosure to the form disclosed herein. Consequently, variations and modifications commiserate with the following teachings, skill, and other knowledge of the relevant art, are within the scope of the present disclosure. The embodiments described herein are further intended to explain modes known of practicing the disclosure and to enable others skilled in the art to utilize the disclosure in such, or other embodiments, and with various modifications required by the particular application(s) or use(s) of the disclosure.

The present disclosure generally relates to seismic monitoring systems that may, for example, facilitate monitoring of subterranean seismic activity. For example, in an embodiment, the seismic monitoring systems discussed herein may be used to monitor hydraulic fracturing operations in a production field. In this regard, the production field may include a plurality of wells where hydraulic fracturing operations or other subterranean activities to be monitored may occur (e.g., to free entrained oil and/or gas from a subterranean formation). The seismic monitoring system described herein may be deployed throughout the production field such that the seismic monitoring system may be employed to monitor different ones of the plurality of wells over an extended period of time (e.g., a duration from months to years).

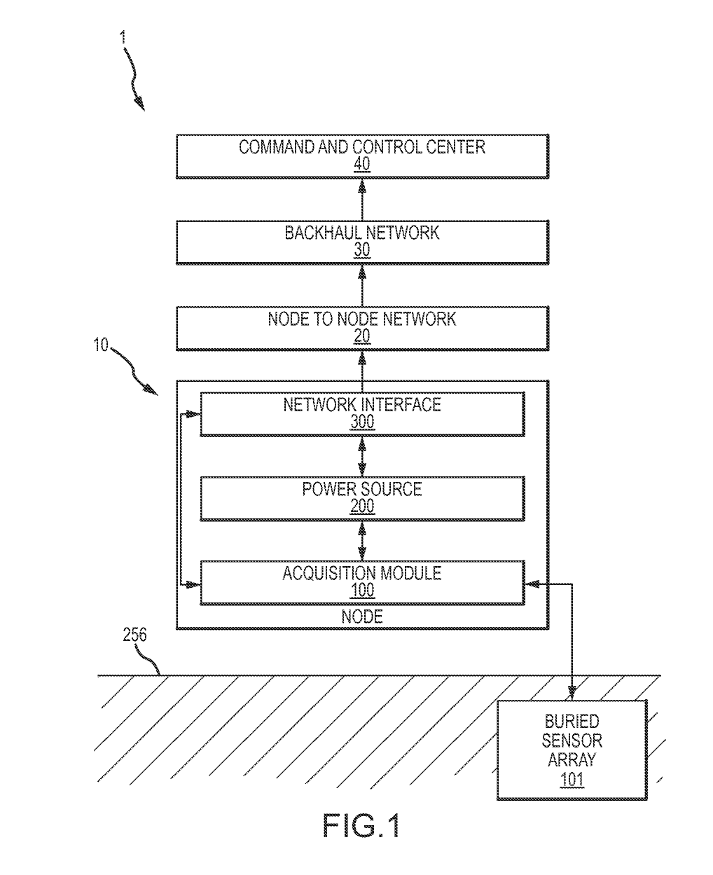

As shown in FIG. 1, an embodiment of a seismic monitoring system 1 may include at least one node 10, a node to node network 20, a back haul network 30, and a command and control center 40. The seismic monitoring system 1 may include at least one buried sensor array 101 (e.g., each including one or more seismic sensors). The buried sensor array 101 may be in operative communication with an acquisition module 100 at the node 10. The buried sensor array 101 may be disposed below entirely below the surface 256 of the Earth. In an embodiment, the buried sensor array 101 is disposed a sufficient distance below the surface 256 such that surface waves (e.g., associated with weather, vehicles, livestock, or other surface disturbances) are substantially isolated from detection at the buried sensor array 101. Accordingly, the sensor array 101 may be disposed at seismically quiet depths (i.e., a depth below the penetration of surface waves). In this regard, the sensor array 101 may be more sensitive to seismic energy originating from a subterranean activity occurring in the production field. Seismically quiet may be defined in at least some embodiments as a signal to surface noise ratio of at least less than about 5:1 or greater.

Additionally, the acquisition module 100 may employ wireless telemetry modalities that may be used to relay acquired seismic and/or auxiliary data to or from the node 10. For example, as shown in FIG. 1, the acquisition module 100 may be in operative communication with a network interface 300. In an embodiment, the network interface 300 may include an antenna (e.g., disposed on a mast). Furthermore, the network interface 300 may include a transceiver that is controllable by the acquisition module 100 to send and receive data via the network interface 300. For instance, the acquisition module 100 may be operable to send and/or receive data from another node 10, a backhaul module of the backhaul network 30, or a control and command center 40 via the network interface 300. As will be described in greater detail below, the acquisition module 100 may be operable to control the network interface 300 to send and/or receive data in relation to acquired seismic data and/or auxiliary data. For example, wireless telemetry techniques for wireless communication may be used in the seismic monitoring system 1 according to any of those described in U.S. Pat. No. 7,773,457, which is hereby incorporated by reference in its entirety. That is, the nodes 10 in the seismic monitoring system 1 may define a serial data transfer path for relaying data from upstream nodes 10 to downstream nodes 10, backhaul modules of the backhaul network 30, and/or a command and control center 40.

As will be described in greater detail below, the relatively short range transfer of data in the node to node network 20 (e.g., along a serial data transfer path) may allow for relatively low power consumption associated with the transmission of seismic and/or auxiliary data between nodes 10. That is, the transmission distance between nodes in the node to node network 20 may be shorter than the transmission distance from a node 10 directly to a backhaul module or the central command and control center 40. As such, the serial data transfer path including a plurality of nodes 10 may provide a low-power wireless telemetry that may be particularly useful in the context of long-term monitoring in a production field for the continuous monitoring of subterranean activities.

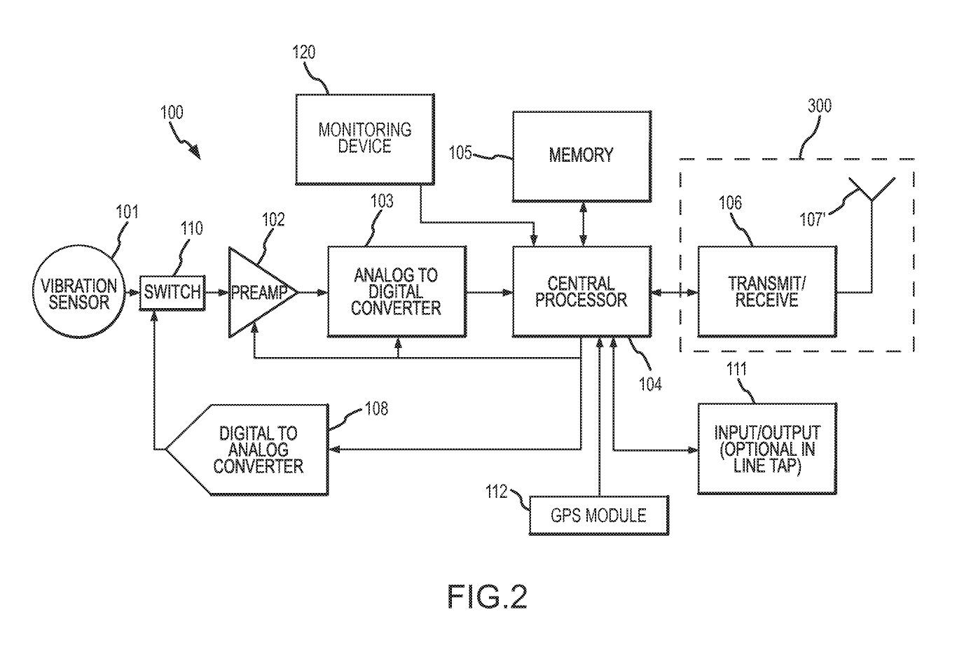

Turning to FIG. 2, a block diagram of an embodiment of an acquisition module 100 is shown that may be employed at a node 10 of a seismic monitoring system 1 as described above. A sensor (e.g., the buried sensor array 101) may convert vibrations into electrical signals which are fed through switch 110 to preamplifier 102 and thence to the analog to digital (ND) converter 103. The digital data from the A/D converter 103 may be fed into the central processor 104 or directly into a digital memory 105. Alternately, in the case of a sensor array 101 with direct digital output, the signals may flow directly to the processor 104 or memory 105. As described above, the sensor array 101 may be buried below the surface as will be described in greater detail below. Additionally, the sensor 101 may include a plurality of discrete sensor components (e.g., the sensor array 101 may be a multi component sensor) and/or comprise a plurality of different sensors 101.

In addition to controlling the system and storing the data in the memory, the processor 104 may perform some calculations on the data including decimation, filtering, stacking repetitive records, correlation, timing, etc. The data acquisition module 100 may also receive information through the transceiver 106, for example: timing information, cross-correlation reference signals, acquisition parameters, test and programming instructions, location information, seismic and auxiliary data from other nodes, and updates to the software, among other commands. The transmit and receive signals couple through antenna 107. In this regard, the transceiver 106 and antenna 107 may comprise at least a portion of the network interface 300 described above with respect to FIG. 1.

The processor 104 can control the transceiver 106, including transmit/receive status, multiplexing signatures, power output, and data flow as well as other functions required for operation. The acquisition module 100 can also receive data and commands from another remote module or base station, store them in the memory, and then transmit them again for reception by another remote module 100 up or down the line.

In one embodiment, the data acquisition module 100 may be operable to both store seismic and/or auxiliary data received from the sensor 101 as well as transmit the seismic and/or auxiliary data to another module or central recording unit. In this regard, the memory 105 may be a data buffer that continually records new data into the buffer while deleting the oldest data from the buffer to free memory space for newly received data. The memory 105 may be sufficient to hold a relatively large amount of data (e.g., approaching or equaling the amount of memory space that would be required to capture the entire survey in memory). For example, the memory 105 may be operable to hold in a data buffer at least about 2 hours, 6 hours, 8 hours, 12 hours, or even days or more, of a seismic data record, or more of a 12 channel acquisition with a sample rate of 60 mbps.

A digital-to-analog (D/A) converter 108 may be included in the system which can accept digital data from the processor 104 to apply signals through a switch 110 to the input circuitry. These signals, which may for example consist of DC voltages, currents, or sine waves, can be digitized and analyzed to determine if the system is functioning properly and meeting its performance specifications. Accordingly, the module may perform one or more self tests. Typical analysis of a self test might include input noise, harmonic distortion, dynamic range, DC offset, and other tests or measurements. Signals may also be fed to the sensor 101 to determine such parameters in connection with a self test as resistance, leakage, sensitivity, damping and natural frequency. As may be appreciated in greater detail based on the discussion below, such analysis or test results may comprise a portion of the auxiliary data that may be transmitted from the module 100. The preamplifier 102 may have adjustable gain set by the processor 104 or other means to adjust for input signal levels. The sensor 101 may be a separate generic unit external to the data acquisition module 100 and connected by cables, or the sensor 101 might be integral to the remote module package.

A data acquisition module 100 may also be used at backhaul module in the backhaul network 30. In this regard, a module 100 may include a “line-tap” or interface to the command and control center. In this regard, the module 100 may have a digital input/output function 111 which may be, for example, an Ethernet, USB, fiber-optic link, or some computer compatible wireless interface (e.g., one of the IEEE 802.11 standards) or another means of communication through a wired or radio link. It may be acceptable to use larger battery packs for a backhaul module rather than acquisition modules because they will normally be relatively few in number and may communicate over greater distances using a high speed data communication protocol.

The data acquisition module 100 may be constructed of common integrated circuits available from a number of vendors. The transmit/receive integrated circuit 106 could be a digital data transceiver with programmable functions including power output, timing, frequency of operation, bandwidth, and other necessary functions. The operating frequency band may be a frequency range which allows for unlicensed operation worldwide, for example, the 2.4 GHz range. The central processor 104, memory 105, and switch 110 can include any of a number of generic parts widely available. The A/D converter 103 could preferably be a 24-bit sigma delta converter such as those available from a number of vendors. The preamplifier 102 may be a low-noise, differential input amplifier available from a number of sources, or alternatively integrated with the A/D converter 103. The D/A converter 108 may be a very low distortion unit which is capable of producing low-distortion sine waves which can be used by the system to conduct harmonic distortion tests.

With reference back to FIG. 1, the node 10 may include a power source 200 for supplying power to the acquisition module 100 and/or the network interface 300. The power supply 200 may comprise at least one of a battery, a solar source, or a wind source. In one example, a solar panel may be utilized as a solar source which may be used to supply power to a battery and/or to the acquisition module 100 directly. In another example, a wind turbine may be used as a wind source to supply power to a battery and/or to the acquisition module 100 directly. The solar source and wind source may be used independently or in conjunction based on, for example, sensed ambient conditions such as solar conditions, wind conditions, etc. In any regard, it may be appreciated that local power generation (e.g., via the solar source, the wind source, or some other appropriate means of local power generation) may be achieved at the node 100.

The data acquisition module 100 may include a monitoring device 120 for monitoring and/or collecting auxiliary data associated with the acquisition module 100. Auxiliary data may include, for example, any type of data other than seismic data collected by the acquisition module 100 via the buried sensor array 101. In one example, as described above, auxiliary data may include information regarding the status of one or more of the components of the module 100 (e.g., based on the module self tests described above). Additionally or alternatively, auxiliary data may be status data regarding the power supply 200. For example, an electrical property such as the level of current supplied to the acquisition module 100 from the power source 200 may be provided as auxiliary data. In this regard, the monitoring device 120 may measure the current supplied from at least one of the battery, solar source, or wind source.

In another example, the auxiliary data may be environmental conditions associated with an environment in which the data acquisition module 100 is disposed (e.g., by way of the monitoring device 120). The environmental conditions associated with the data acquisition module 100 may include at least one of noise, ambient weather, orientation of the data acquisition module 100, or other ambient conditions. Noise may include erroneous signals (e.g., that may be detected at the surface by the monitoring device 120 rather than from the buried sensor array 101) that result from livestock, vehicles, weather, or other events capable of introducing noise to the seismic monitoring system 1. Ambient weather may include at least one of temperature, a solar condition, or a wind condition. For example, if locally generated power (e.g., a solar source or wind source) is provided, an alternative source of energy may be used in a case where ambient conditions do not support local generation of power (e.g., when little to no wind is present, solar conditions are poor, or other factors that affect local power generation).

Furthermore, the auxiliary data may be used to troubleshoot the power supply 200 (e.g., logic may be present locally or analysis of the auxiliary data may occur remotely such as at the command and control center 40). For example, if suitable ambient conditions exist for local power generation, yet the monitoring device 120 detects deficient amounts of power being generated, an alert may be generated indicating that an issue exists with one or more of the power supplies. For example, solar sensors may indicate good solar conditions, yet little power generation from a solar source indicating a potential problem (e.g., a malfunctioning solar source or an obstruction such as snow or the like). Similarly, if locally generated power is being supplied, yet a battery is not charging, the auxiliary data may indicate an issue with a battery. Furthermore, if the monitoring device 120 is capable of detecting an orientation (e.g., the tilt angle, acceleration, or other parameter regarding the data acquisition module 100), an alert may be generated that an unusual condition has occurred (e.g., the module 100 is being stolen, moved by livestock, disturbed by weather, etc.).

In yet another example, auxiliary data may include a status of the data acquisition module 100. For example, the status of the data acquisition module may include a power state, operating conditions, or signal quality of data received by the sensor array 101 (e.g., as described above with regard to the self test functionality of the module 100). In this regard, the auxiliary data may further include data regarding acquired seismic data properties. For example, the acquired seismic data properties may include signal to noise ratio, amplitude, frequency, motion, velocity, direction of propagation, to name a few. The auxiliary data may further include noise associated with operation of any component, subsystem, device, etc. of the data acquisition module 100. For example, the auxiliary data may include the signal to noise ratio of acquired seismic data as it's processed by each data acquisition module 100 and/or transmitted to a plurality of data acquisition modules 100. Acquiring and processing auxiliary data may facilitate improved performance and may reduce maintenance of the seismic survey system.

Furthermore, the data acquisition module 100 may include a number of other components not shown in FIG. 1, such as a directional antennae for AOA signal measurements, separate transmit and receive antennae, separate antennae for location signals and seismic data transfer signals, GPS receivers, batteries, etc.

As briefly referenced above, the seismic monitoring system 1 may also include a note to node network 20, a backhaul network 30, and a command-and-control center 40. The note to node network 20 may include a plurality of nodes operable to communicate between one another. For example, a plurality of nodes 10 may form a serial data transfer path. This concept will be described in greater detail below, the generally the noted node network 20 may allow for communication of data between nodes 10 such that data is transferred from an upstream node 10 to a downstream node 10 such that data travels toward a backhaul module in the backhaul network 30 and/or a command-and-control center 40. That is, the noted node network 20 may facilitate wireless readout of data from nodes 10. In this regard, any of the wireless vacation modalities described in U.S. Pat. No. 7,773,456 which is incorporated by reference above, may be utilized in the noted node network 20.

That is, nodes 10 may be assigned multiplexing signatures such that multiple nodes (e.g., more than one node 10 in a common serial data transfer path) may communicate in the node to node network 20 and avoid interference. For example, a first node 10 may be assigned a first multiplexing signature (e.g., corresponding to a code, frequency, time period etc.) and a second node 10 within transmission range of the first node 10 may be assigned a second multiplexing signature such that the first node 10 and the second node 10 may transmit and avoid interference by way of use of the different multiplexing signatures. For example, even nodes 10 within a single serial data transfer path may simultaneously transmit utilizing different multiplexing signatures at the same time. Furthermore, multiplexing signatures allocated between adjacent serial data transfer lines may also be provided so as to avoid interference among nodes 10. In this regard, high-speed data readout may be facilitated through multiple nodes 10 transmitting simultaneously as facilitated by the use of disparate multiplexing signatures at various ones of the nodes 10.

In an embodiment, the node to node network 20 may employ a 2.4 GHz radiofrequency infrastructure. Such radio may provide a range of 1 mile between nodes 10 that have a line of sight between one another. As will be described below, the use of the 2.4 GHz radio may provide low power consumption through the use of a serial data transfer path utilizing node to node communications. As will also be described in greater detail below, the node to node network 20 may include transmissions between antennas 107 (e.g. antennas mounted on 10 or 20 foot masts to increase transmission distances).

Additionally, the seismic monitoring system 1 may include a backhaul network 30. The backhaul network may utilize a 2.4 GHz radio in order to receive data from the noted node network 20. Furthermore, the backhaul network 30 may facilitate data communication between backhaul modules, for example, using the 5.8 GHz radio. The backhaul modules may include larger antenna masts (e.g., 30 foot to 50 foot multi-sectional masts) to facilitate long-range radio communication. In another embodiment, the backhaul network 30 may utilize a 900 MHz non-line of sight transmission modality to communicate data between backhaul modules. Furthermore, a 3G/4G VPN modality may also be employed by the backhaul network 30.

The seismic monitoring system 1 may also include a command and control center 40. The command and control center 40 may be able to receive data directly from the node to node network 20 and/or from the backhaul network 30. In this regard, the command and control center 40 may include any appropriate corresponding radio modality (e.g., 2.4 GHz radio, 5.8 GHz radio, 900 MHz radio, 3G/4G VPN capability, etc.) in order to facilitate receipt of data from nodes and/or backhaul modules.

The command-and-control center 40 may be able to store data received from nodes 10 (e.g., for later processing and/or real-time troubleshooting of nodes 10). In this regard, the command and control center 40 may include one or more computing devices capable of processing the data (e.g., for storage and/or real-time display). For instance, the command and control center 40 may provide a human operator a user interface for control and real time monitoring of status of the nodes 10.

As mentioned above, the seismic monitoring system 1 may have advantageous power consumption properties. For example, in the note to node network 20, the transmission distance between nodes 10 may be less than the transmission distance to a backhaul module of the backhaul network 30. In this regard, use a serial data transfer path to provide for shorter transmission distances in the note to node network 20. Given the shorter transmission distances, less power may be used in transmitting data from one node to another in the note to node network 20, thus conserving a power supply 200 of the node.

Furthermore, the data acquisition module 100 and/or the buried sensor array 101 may have at least three power states. For example, the power states may include at least one of a sleep state, a low power state, and/or an acquisition state. The sleep state may include powering off and/or lowering power consumption of the acquisition module 100 and/or a component of the sensor array 101. The power source 200 (e.g., a battery) may continue to be charged while the system is in the sleep state (e.g., using local power generation). The low power state may include reducing power consumption of the data acquisition module 100 and/or sensor array 101 to one of several levels.

For example, in the low power state, the acquisition module 100 and/or at sensor array 101 may consume only about 10%, 25%, or 50% of the power consumed during the acquisition state. The power source 200 (e.g., a battery) may continue to be charged (e.g., using local power generation) while the system is in the low power state. The acquisition module 100 and/or the sensor array 101 may transition to the low power state for extended periods such as from hours to many months. The acquisition state may include the acquisition module 100 and/or sensor array 101 consuming enough power such that the sensor array 101 may acquire data and the data acquisition module 100 may receive and/or transmit data for extended periods of time such as from hours to several months. In turn, the data acquisition module 100 may be deployed in a production field for days, months and/or years without requiring replacement of a power source 200.

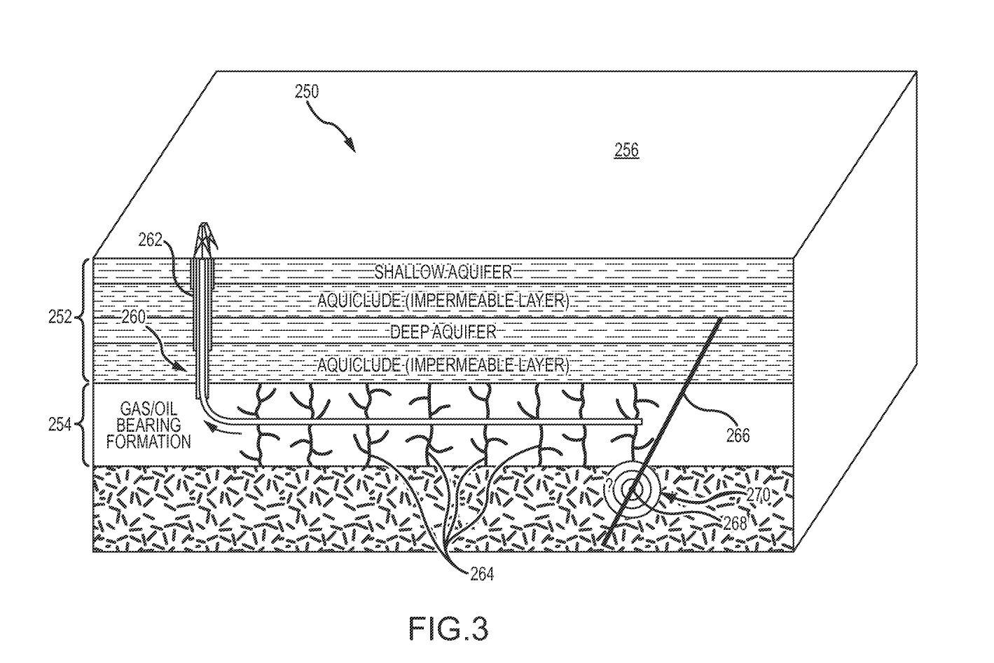

With reference now to FIG. 3, a cross-section is shown of an of a plurality of subterranean layers 250 in which a subterranean activity (e.g., a hydraulic fracturing operation) may be performed. A hydraulic fracturing operation generally may include drilling a well 260 that extends through a plurality of layers 252 below the surface 256 and eventually penetrates a gas or oil bearing formation 254. Once the gas or oil bearing formation 254 has been reached, the well 260 may optionally be directionalized to extend for a distance through the gas or oil bearing formation 254. Portions of the well 260 extending through the plurality of layers 252 above the gas or oil bearing formation 254 may be isolated from those layers 252 by well casings 262 established using various well casing techniques.

Once the well 260 is established in the gas or oil bearing formation 254, the hydraulic fracturing operation may include introduction of fracturing fluid into the well 260 at high pressure. As result, new or existing fractures 264 in the gas or oil bearing formation 254 may be created or existing fractures 264 may be widened in response to the high-pressure introduction of fracturing fluid into the well 260. Such hydraulic fractures 264 may allow for passage of entrained oil or gas to flow through the resulting hydraulic fractures 264 into the well 260. As may be appreciated, such operations may increase oil production by freeing entrained oil or gas.

It may also be appreciated that the hydraulic fracturing operation, when creating hydraulic fractures 264, may also generate seismic energy may that propagate through the subterranean layers 250 as a result of the fracturing operation. As such, the seismic energy created by the subterranean activity may be detectable by seismic sensors. Accordingly, it may be possible to monitor the hydraulic fracturing operation to discern information regarding the operation including, for example, fracturing effectiveness, fracturing location, and/or to monitor for any induced seismic activity associated with existing fault lines 266 or the effect of the operation on other subterranean geological features. For example, in an embodiment, the seismic data collected resulting from the fracturing operation may provide information regarding a hydrocenter 268 and/or magnitude 270 (represented by the concentric circles in FIG. 3) of micro-earthquakes associated with the hydraulic fracturing operation. However, the manner in which seismic sensors are disposed in a production field may greatly affect the quality of the seismic data collected.

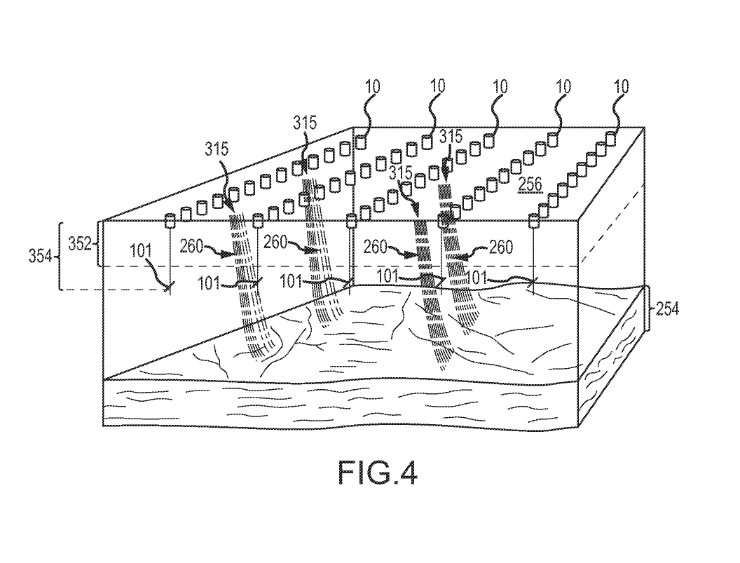

For example, turning to FIG. 4, a representation of a production field 300 is depicted. As can be appreciated in FIG. 3, the production field 300 may include a plurality of well sites 315 disposed throughout the production field 300. Each well site 315 may include a plurality of wells 260 extending into an oil or gas bearing formation 254 such that hydraulic fracturing operations may be performed at the wells 260. As discussed above, one prior approach to monitoring subterranean activities such as hydraulic fracturing has been to deploy sensors into a well 260 to receive seismic activity resulting from the subterranean activities. However, this may require taking a well 260 out of production such that the well may be dedicated to monitoring. In the context of an active production field 300, taking a well 260 out of production in this manner may be cost prohibitive as a result of the loss in production of the well 260 used in the monitoring process.

Another approach to monitoring subterranean activities has been to deploy sensors on the surface to monitor the subterranean activity. However, as can be appreciated in FIGS. 3 and 4, the gas or oil bearing formation 254 may be disposed relatively deep below the surface 256 of the Earth such that any seismic energy generated from the subterranean activities may be relatively weak once the energy has reached the surface 256. As such, any seismic energy reaching the surface 256 may be difficult to discern from surface noise such as weather, livestock, vehicles, or other surface noise (i.e., the signal to noise ratio of surface monitoring may be insufficient for meaningful monitoring).

Thus, with reference again to FIG. 4, the seismic monitoring system 1 described herein may include buried sensor arrays 101 that shown in FIG. 4 in relation to selected ones of the nodes 10 for illustration purposes. However, as may be appreciated like buried sensor arrays 101 may be provided with each of a plurality of predetermined surface locations or nodes 10 having an acquisition module 100. In any regard, the buried sensor arrays 101 may include a plurality of sensors that may each have a plurality of sensor components (e.g., an x component, a y component, and a z component each disposed orthogonally to one another). The sensor array 101 may be disposed below the surface such that surface noise may be isolated from the sensors 101.

For example, a layer 352 near the surface 256 may be referred to as the weathered layer 352. The weathered layer 352 may correspond to a near-surface, possibly unconsolidated, layer of low seismic velocity. The base of the weathered layer 352 commonly coincides with the water table and a sharp increase in seismic velocity. The weathered layer 352 typically has air-filled pores. In this regard, it may be appreciated that for different locales, the weathered layer 352 may extend to different depths below the surface 256. Accordingly, in an embodiment, the sensor arrays 101 may be disposed at a depth 354 below the weathered layer 352. The sensor arrays 101 may be disposed at a depth 354 below the weathered layer 352 not less than about 20 m and not more than about 500 m. For instance, the weathered layer 352 may extend from the surface of the Earth to a depth of not less than about 5 m and not more than about 100 m below the surface 256. In an embodiment, the sensor arrays 101 may be disposed at a depth 354 that is at least about 1.1 times the depth of the weathered layer 352 and not more than about 2 times the depth of the weather layer 252.

As discussed above, each well site 315 may include one or more wells 260 extending into an oil or gas bearing formation 254 such that hydraulic fracturing operations may be performed at one or more of the wells 260. As such, each well 260 may be employed in a subterranean activity, e.g., hydraulic fracturing, at a first depth below the surface of the Earth generally corresponding to the depth of the oil or gas bearing formation 254. Accordingly, the sensor arrays 110 may be disposed at a second depth 354 not less than about 10% of the first depth and not more than about 70% of the first depth. For example, the sensor arrays 110 may be disposed at a depth 354 that is a fraction of the depth at which the seismic activities to be monitored occur. In another example, the sensor arrays 110 may be disposed at depth below the surface of the Earth not less than 20 m and not more than 500 m.

The buried sensor array 101 may be provided in locations separate from well sites 315 such that wells 260 are not required to be taken out of production in order to receive the sensor arrays 101. Furthermore, the buried sensor arrays 101 may be disposed at a depth 354 above the terminal depth of the wells 260. In turn, less costly techniques may be used to bury the sensor arrays 101. For example, less sophisticated or less costly well casing techniques may be employed. Furthermore, less costly equipment may be used to form the sensor holes into which the sensor arrays 101 are disposed. Additionally, the array of buried sensor arrays 101 separate from well sites 315 may facilitate improved seismic data acquisition. For example, seismic energy existing in locations separate from well sites 315 may be acquired by the array of buried sensors 101, where in the prior approach of deploying sensors into the well, the sensors only acquired seismic energy existing inside the well. In other words, the sensor arrays 101 may be disposed more densely throughout the production field 300 than could sensors disposed in wells 260.

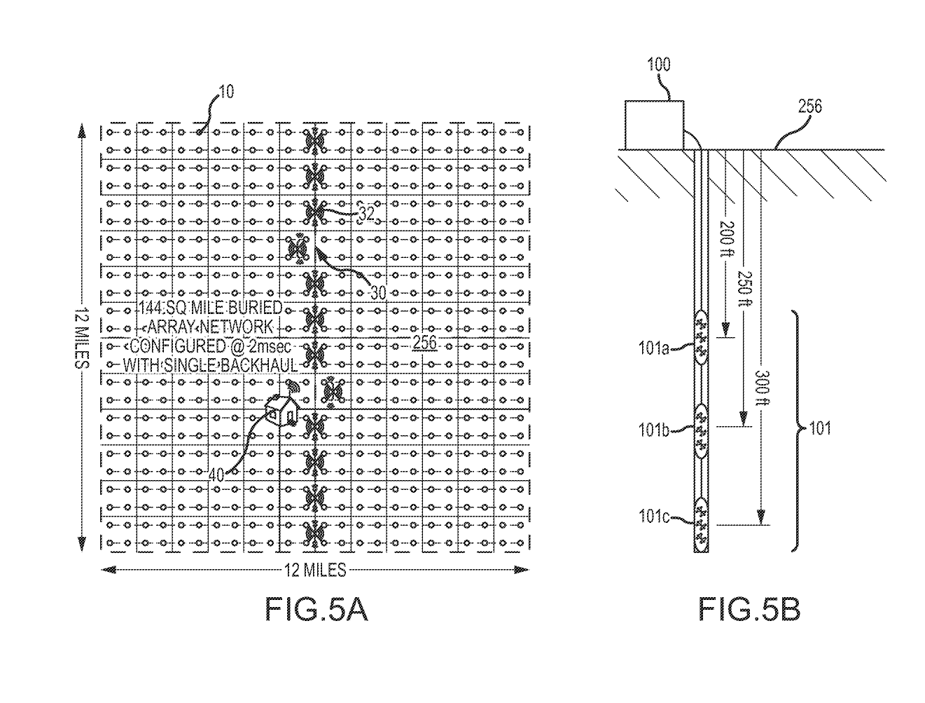

One embodiment of a plurality of distributed nodes 10 is shown in FIG. 5A. As shown in FIG. 5A, the nodes 10 may be disposed at the surface 256 of the Earth. In this illustration, the seismic monitoring system may include, for example, a 144 square mile grid with four nodes 10 per square mile. Each node 10 may include a buried sensor array 101 and may be capable of receiving acquired data on as many as nine distinct channels. As such, the seismic survey system may be capable of receiving acquired data on as many as 5000 channels.

With further reference to FIG. 5B, each data acquisition module 100 of each node 10 may be in operative communication with more than one sensor 101a, 101b, and 101c disposed below the surface 256. That is, each sensor array 101 may include one or more sensors 101a-101c. The sensors 101a-101c may each include a three component (3C) sensor. Each component of the 3C sensor may output acquired seismic data. One component of the 3C sensor may output acquired seismic data in a first circumstance. Two components of the 3C sensor may output acquired seismic data in a second circumstance. Three components of the 3C sensor may output acquired seismic data in a third circumstance. For example, the first circumstance may include transitioning one component of the 3C sensor to the acquiring state and two components of the 3C sensor to the sleep state. In another example, the second circumstance may include transitioning two components of the 3C sensor to the acquiring state and one component of the 3C sensor to the sleep state. In yet another example, the third circumstance may include transitioning three components of the 3C sensor to the acquiring state. One or more 3C sensor may be provided in operative communication with each data acquisition module 100. As such, each sensor 101 and/or each component of the three component sensor may communicate with a data acquisition module 100 in a separate channel such that the data acquisition module 100 receives multichannel communications from the sensor array buried below the surface 256 of the Earth.

The buried sensor array may include sensors 101a-101c at a plurality of depth levels. For example, at least three different depths of sensors 101a-101c may be provided at different depths below the surface 256. In general, the sensors 101a-101c may be disposed below the surface of sufficient depth such that surface waves (i.e., seismic waves propagating through the Earth originating from the surface) do not reach the buried sensor array 101 or are sufficiently attenuated to provide low amounts of noise, e.g., a signal to noise ratio of 5:1 or greater.

In any regard, each sensor 101a-101c may communicate acquired data to the data acquisition module 100 on a distinct channel. As such, as few as three and as many as twelve or more channels of acquired data may be received by the processor 104 of the data acquisition module 100 from the buried sensor array 101. In the case where three channels of acquired data are received by the processor 104 of the data acquisition module 100, the data acquisition module 100 may consume less than 200 mW of power per channel.

In turn, the acquired data may be transmitted wirelessly along a plurality of serial data transfer paths toward a backhaul module 32 in the backhaul network 30. Once the acquired data is received at a backhaul module 32, the backhaul network 32 may function to transmit the data on towards a central recording station 40 where the data may be stored and/or processed.

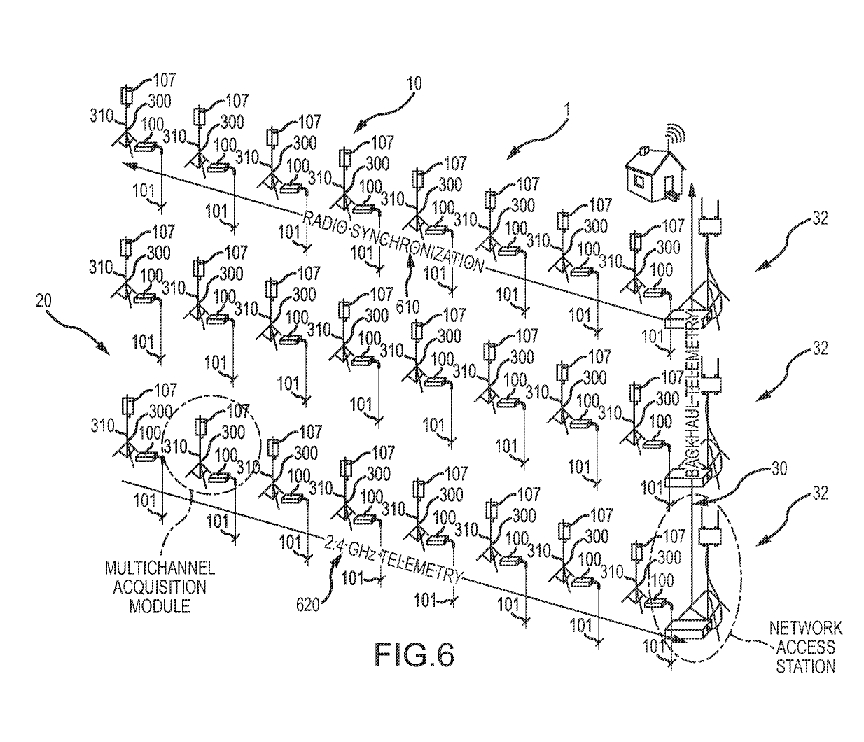

With further reference to FIG. 6, an embodiment of a seismic monitoring system 1 is depicted. As may be appreciated, a plurality of nodes 10 may be deployed that may include a network interface 300 in operative communication with an acquisition module 100 that is in further communication with a buried sensor array 101. FIG. 6 also depicts a plurality of backhaul modules 32 form a portion of the backhaul network 30. Also, a command and control center 40 is depicted.

In this regard, as shown in FIG. 6, control data 610 (e.g., including potentially radio synchronization data as shown in FIG. 6) may be provided from the command and control center 40 to a backhaul module 32 and in turn up the node to node network 20 such that the control data 610 is passed along a serial data transfer path formed by the nodes 10 in the node to node network 20. That is, control data 610 may be passed from the command and control center 40 to the nodes 10 in the node to node network 20 such that the node to node network 20 distributes the control data 610 among the nodes 10. As referenced above, the control data 610 may be synchronization data such as, for example, radio synchronization data as described in U.S. Pat. No. 8,220,757 entirety of which is incorporated by reference herein. Other control data 610 may be included as well such as, for example, sleep/wake commands, multiplexing control data, configuration data, or other data to be communicated to the nodes 10.

FIG. 6 also depicts an example of data transfer 620 from remote nodes 10 toward a backhaul module 32. In this regard, the data transfer 620 may occur along the node to node network 20 to a backhaul module 32. For example, as described above, the node to node network 20 may include a 2.4 GHz telemetry radio modality for transferring the data 620. It may be appreciated data 620 may include acquired seismic data from one or more of the nodes 10 and/or auxiliary data as described above. In any regard, once the data 620 reaches the backhaul module 32, the backhaul module 32 may pass data toward the command and control center 40 using the backhaul network 30. In this regard, the backhaul network 30, as described above may be one of any number of a plurality of communication modalities. In any regard, the data 620 may be eventually passed to the command and control center 40 for storage and/or processing described above. It should be noted that the backhaul module 32 may include a acquisition module 100. In this regard, the controller at the backhaul module 32 may be similar to that of a node 10, with the exception the generally the acquisition module 100 at the backhaul module 32 may not acquire seismic data. However, in some embodiments, backhaul module 32 may include an active seismic sensor array 1014 collection of seismic data as well.

As depicted in FIG. 6, the acquisition module 100 may be in operative communication with a network interface 300. In this regard, network interface 300 may be a surface deployed mast 310 with an antenna 107 supported on the mast 310. The surface deployed masts 310 may provide for relatively low cost and easy setup that may be used for relatively short durations.

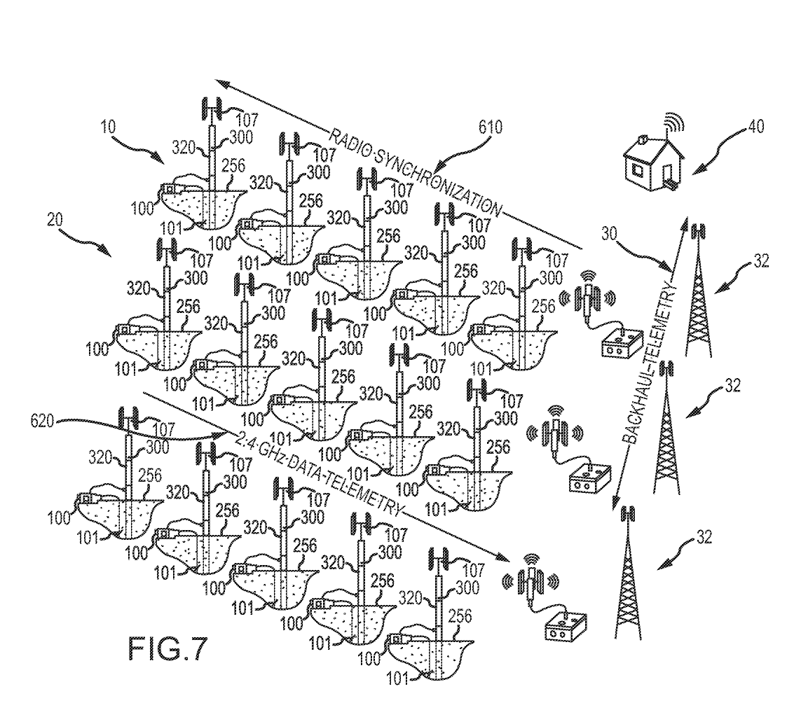

In contrast, FIG. 7 depicts an alternative embodiment of a seismic monitoring system 1. In this regard, seismic monitoring system 1 may function similarly to that is described in FIG. 6 with both control data 610 been shown passed along the node to node network 20 and data 620 being collected from the node to node network 20. Notably, the nodes 10 depicted in FIG. 7 may include a network interface 300 comprising a antenna 107 disposed on a mast 320 which is at least partially secured below the surface 256. In this regard, the mast 320 shown in FIG. 7 may allow for positioning of the antenna 107 of the network interface 300 at a height greater than what may be achieved using the surface deployed mass 310 shown in FIG. 6. Accordingly, the mast 320 may provide for higher transmission distances. As such, the masts 320 may be suited to relatively long term deployments (e.g., months or more).

An embodiment of a node 10 is shown in detail in FIG. 8. In this regard, the node 10 may include an acquisition module 100 that is in operative communication with a burred sensor array 101 disposed below the surface 256. Furthermore, the acquisition module 100 may be in operative communication with a network interface 300 comprising an antenna 107 disposed on top of a mast 320 which is at least partially secured under the surface 256. It may be appreciated other components (e.g., a power source such as a battery, solar source, wind source, etc.) may also be provided at the node 10.

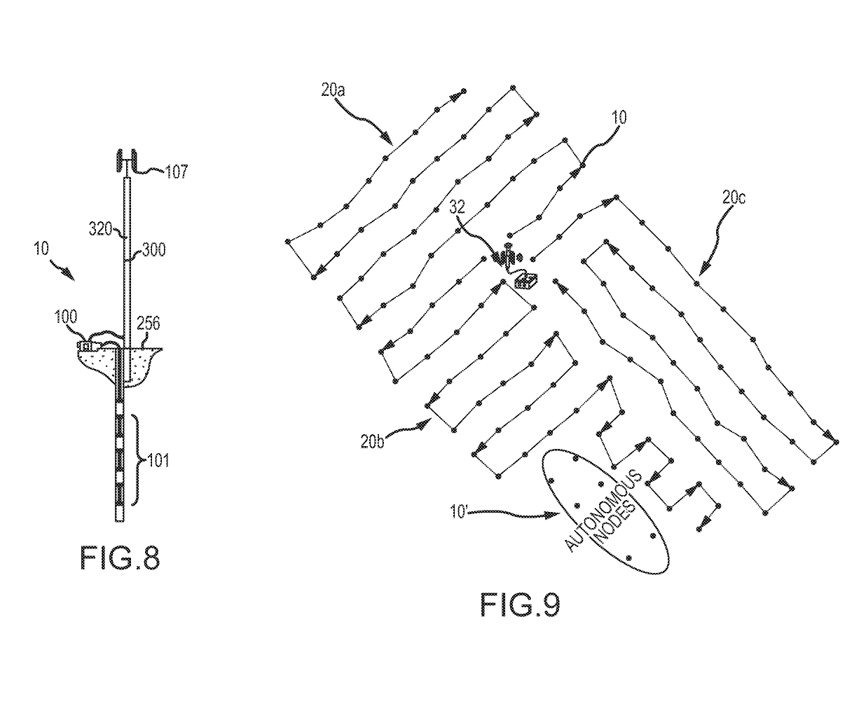

As depicted in FIG. 9, a plurality of nodes 10 may form one or more serial data transfer paths 20a-20c for passing data from the node to node networks 20a-20c to a backhaul module 32. As may be appreciated, the node to node networks 20a-20c may be arranged in any practical shape such that serial data transfer paths may be circuitous and/or geometrically regular (e.g. a grid) through the nodes forming the node to node network 20. As may be appreciated, multiplexing signatures may be assigned within or among the node to node networks 20a-20c to avoid collisions when transmitting data therebetween.

With further reference to FIG. 9, a portion of the nodes 10′ in the deployed system 1 may be autonomous. In this regard, the autonomous nodes 10′ may not include radio telemetry capabilities and/or have radio telemetry capabilities disabled. In this regard, data collected by the autonomous nodes 10′ may be stored locally for later retrieval. Furthermore, the autonomous nodes 10′ may operate part-time in an autonomous mode and part-time in a wireless mode for data communication. For example, the autonomous nodes 10′ be read out data at the conclusion of the survey or other convenient time.

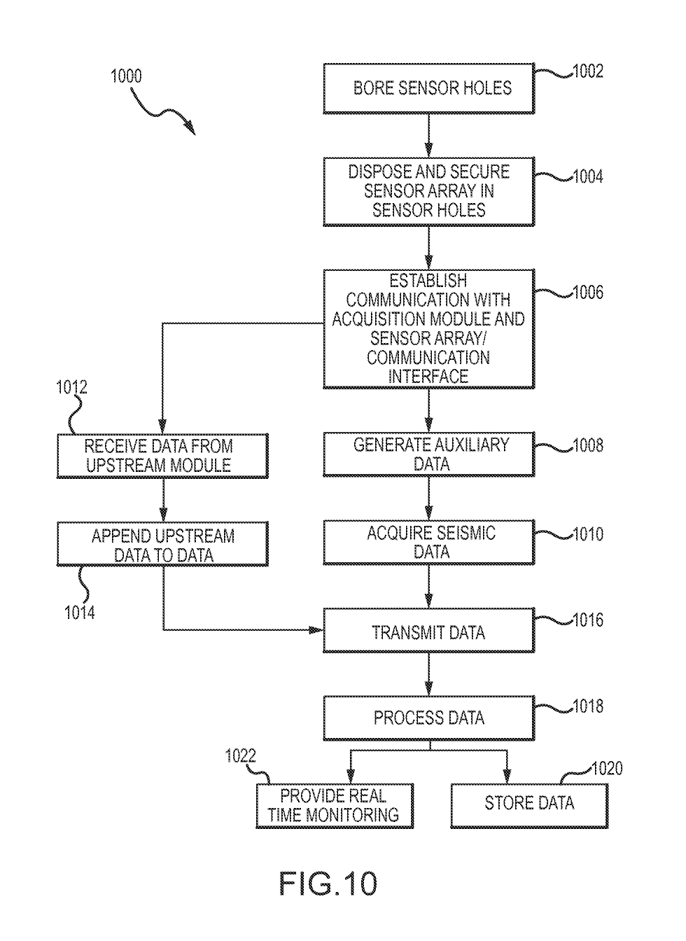

FIG. 10 depicts an embodiment of a method 1000 of operation of a seismic monitoring system as described above. In this regard, the method 1000 may include boring 1002 one or more sensor holes. As described above, the sensor holes may be drilled using less costly techniques and/or equipment than usually associated with boring production wells 260. For example, the sensor holes may be shallower than a production well and/or require less sophisticated casings. In this regard, the sensor holes may be board using for example, commonly available boring equipment (e.g., used commonly for water wells) or other drilling platforms that may be much less costly to operate than oil and gas production drilling platforms.

The method 1000 may also include disposing and securing 1004 a sensor array 101 in each of the sensor holes. For example, the sensor arrays 101 may be placed within the sensor holes and secured 1004 therein (e.g., by cementing sensors in place). In any regard, the sensor arrays 101 disposed in the sensor holes may be secured 1004 such that the sensor arrays 101 are capable of detecting seismic activity at the location of the sensor array 101.

The method 1000 may also include establishing 1006 communication with acquisition module and the sensor array 101 and/or a communication interface 300. In this regard, the acquisition module 100 may be in operative communication with the sensor array 100 to receive acquired seismic data therefrom. Furthermore, acquisition module 100 may be in operative communication with communications interface 300 as described above for transmitting data from or receiving data at the acquisition module 100. In this regard, in one embodiment, the method 1000 may include generating 1008 auxiliary data at the acquisition module 100. For example, as discussed above, the auxiliary data may include non-seismic data such as metadata regarding seismic data, acquisition module parameters, or other information such as ambient conditions, power source information, or other appropriate information. Furthermore, the method 1000 may include acquiring 1010 seismic data at the acquisition module.

Additionally or alternatively, after establishing 1006 communication between the acquisition module and a sensor array 101 and a communication interface 300, the method 1000 may include receiving 1012 data from an upstream module. As may be appreciated, the data received 1012 from the upstream module may include seismic data was acquired by one or more upstream modules and/or auxiliary data corresponding to one or more upstream modules. In this regard, the method 1000 may also include appending 1014 upstream data to data that is either generated 1008 or acquired 1010 at the acquisition module 100.

In any regard, a method 1000 may include transmitting 1016 data (e.g., received 1012 data, generated 1008 data, and/or acquired 1010 data) from the acquisition module 100. For example, the transmitting 1016 may include transmission to another node 10 and/or acquisition module 100 (e.g., in the node to node network 20), a backhaul module 32 in a backhaul network 300, and/or a control and command center 40.

In this regard, the method 1000 may include processing 1018 data. For example, the processing 1018 may occur at an acquisition module 100 and/or at a command and control center 40. In any regard, the processing 1018 may allow for storage 1020 of data (e.g., for later use in analyzing a subterranean activity). Additionally, the processing 1018 may allow for providing 1022 real-time monitoring based on the data (e.g., seismic data and/or auxiliary data). For example, the above-noted alerts and/or other information relating to the seismic monitoring system 1 may result from the real time monitoring provided 1022 based on the processing 1018 of the data.

It will be readily appreciated that many deviations may be made from the specific embodiments disclosed in the specification without departing from the spirit and scope of the present described technology. Also, it should be understood that the functionalities performed by many of the processes and subsystems discussed herein may be performed by other subsystems, processes, etc. The illustrations and discussion herein has only been provided to assist the reader in understanding the various aspects of the present disclosure. Furthermore, one or more various combinations of the above discussed arrangements and embodiments are also envisioned.

What is claimed is:

1. A data acquisition module for use in seismic data acquisition, comprising:
at least one buried seismic sensor operable to output acquired seismic data;
a processor in operative communication with the buried seismic sensor to receive the acquired seismic data;
a transmitter in operative communication with the processor for transmitting the acquired seismic data to one of a downstream data acquisition module or a data collection unit; and
a receiver in operative communication with the processor for receiving seismic data from an upstream data acquisition module;
wherein the data acquisition module is disposed in a serial data transfer path of an array of a plurality of data acquisition modules.

2. A module according to claim 1, wherein the buried seismic sensor is disposed completely below the surface of the Earth.

3. A module according to claim 1, wherein a plurality of buried seismic sensors are in operative communication with the processor, wherein different respective ones of the plurality of seismic sensors are disposed at different corresponding depths below the surface of the Earth.

4. A module according to claim 1, wherein the data acquisition module is deployed into a production field comprising a plurality of wells, wherein at least one of the wells is employed in a subterranean activity at a first depth below the surface; and
wherein the buried seismic sensor is disposed at a second depth not less than about 10% of the first depth from the surface and not more than about 70% of the first depth from the surface.

5. A module according to claim 4, wherein the subterranean activity comprises hydraulic fracturing.

6. A module according to claim 5, wherein the seismic data comprises a hydrocenter and a magnitude of a seismic event corresponding to the hydraulic fracturing.

7. A module according to claim 7, wherein the buried seismic sensor is disposed at a depth below the weathered layer.

8. A module according to claim 7, wherein the buried seismic sensor is disposed at a depth below the weathered layer not less than 5 m and not more than 200 m.

9. A module according to claim 8, wherein the weathered layer extends from the surface of the Earth to a depth of not less than 5 m and not more than 100 m below the surface of the Earth.

10. A module according to claim 1, wherein the buried seismic sensor is disposed at a depth below the surface of the Earth not less than 5 m and not more than 500 m.

11. A module according to claim 1, wherein the buried seismic sensor is disposed at a depth below the surface of the Earth sufficient to substantially isolate the plurality of buried seismic sensors from seismic waves originating at the surface.

12. A module according to claim 1, wherein the buried seismic sensor is disposed at a depth below the surface of the Earth such that a signal to surface noise ratio is less than about 5:1.

13. A module according to claim 1, wherein the buried seismic sensor comprises a three component sensor, and wherein each component of the three component sensor is operable to output acquired data.

14. A module according to claim 13, wherein the processor is configured to receive the output seismic data from one component of the three component sensor in a first circumstance, from two components of the three component sensor in a second circumstance, and from all three components of the three component sensor in a third circumstance.

15. A module according to claim 14, wherein the first circumstance comprises activating one component of the three component sensor, wherein the second circumstance comprises activating two components of the three component sensor, and wherein the third circumstance comprises activating three components of the three component sensor.

16. A module according to claim 1, wherein the processor is operable to communicate auxiliary data to the transmitter for transmission to at least one of another data acquisition module, a data collection module, or a command and control center.

17. A module according to claim 16, wherein the auxiliary data comprises status information regarding at least a portion of the module.

18. A module according to claim 17, wherein the auxiliary data comprises status data regarding the buried seismic sensor.

19. A module according to claim 16, further comprising:
a power supply for supplying power to the data acquisition module.

20. A module according to claim 19, wherein the power device comprises at least one of a battery, solar source, or wind source.

21. A module according to claim 19, wherein the auxiliary data comprises status data regarding the power device.

22. A module according to claim 16, wherein the auxiliary data comprises environmental conditions in which the data acquisition module is disposed.

23. A module according to claim 22, wherein the environmental conditions associated with the data acquisition module includes at least one of noise, ambient weather, or orientation of the data acquisition module.

24. A module according to claim 23, wherein the ambient weather comprises at least one of temperature, a solar condition, or a wind condition.

25. A module according to claim 23, wherein the orientation of the data acquisition module comprises a tilt angle.

26. A method for use in data acquisition, comprising the steps of:
disposing at least one seismic sensor at a predetermined depth below the surface of the Earth at a plurality of corresponding predetermined surface locations;
establishing operative communication between a data acquisition module and the at least one seismic sensor at each of the plurality of predetermined surface locations;
creating a wireless serial data transfer path between one or more of the data acquisition modules at the plurality of predetermined surface locations for relaying data from an upstream acquisition module to at least one of a downstream acquisition module, a data collection module, or a command and control center;
receiving acquired seismic data from the at least one seismic sensor at least at a portion of the acquisition modules; and
wirelessly communicating the acquired seismic data along the wireless serial data transfer path.

27. A method according to claim 26, wherein the disposing comprises burying the seismic sensor completely below the surface of the Earth.

28. A method according to claim 26, wherein the plurality of predetermined surface locations are in a production field comprising a plurality of wells, wherein at least one of the wells is employed in a subterranean activity at a first depth below the surface; and
wherein the disposing comprises locating the at least one seismic sensor at a second depth not less than about 10% of the first depth from the surface and not more than about 70% of the first depth from the surface.

29. A method according to claim 28, wherein the subterranean activity comprises performing hydraulic fracturing at the first depth.

30. A method according to claim 29, wherein the seismic data comprises a hydrocenter and a magnitude of a seismic event corresponding to the hydraulic fracturing.

31. A method according to claim 26, wherein the disposing comprises burying the seismic sensor at a depth below the weathered layer.

32. A method according to claim 31, wherein the disposing comprises burying the seismic sensor at a depth below the weathered layer not less than 5 m and not more than 100 m.

33. A method according to claim 31, wherein the weathered layer extends from the surface of the Earth to a depth of not less than 5 m and not more than 100 m below the surface of the Earth.

34. A method according to claim 26, wherein disposing comprises burying the seismic sensor at a depth below the surface of the Earth not less than 5 m and not more than 500 m.

35. A method according to claim 26, wherein the disposing comprises burying the seismic sensor at a depth below the surface of the Earth sufficient to substantially isolate the plurality of buried seismic sensors from seismic waves originating at the surface.

36. A method according to claim 26, wherein the disposing comprises burying the seismic sensor at a depth below the surface of the Earth such that a signal to surface noise ratio is less than about 5:1.

37. A method according to claim 26, further comprising:
communicating auxiliary data from the data acquisition module to at least one of anther data acquisition module, a data collection module, or a command and control center.

38. A method according to claim 37, wherein the auxiliary data comprises status information regarding at least a portion of the module.

39. A method according to claim 38, wherein the auxiliary data comprises status data regarding the buried seismic sensor.

40. A method according to claim 37, further comprising:
supplying power to the data acquisition module from a power supply.

41. A method according to claim 40, wherein the power supply comprises at least one of a battery, solar source, or wind source.

42. A method according to claim 40, wherein the auxiliary data comprises status data regarding the power supply.

43. A method according to claim 37, wherein the auxiliary data comprises environmental conditions in which the data acquisition module is disposed.

44. A method according to claim 43, wherein the environmental conditions associated with the data acquisition module includes at least one of noise, ambient weather, or orientation of the data acquisition module.

45. A module according to claim 44, wherein the ambient weather comprises at least one of temperature, a solar condition, or a wind condition.

46. A module according to claims 44, wherein the orientation of the data acquisition module comprises a tilt angle.
